(19) United States
(12) Patent Application Publication
(10) Pub. No.: US 2013/0305251 A1
(43) Pub. Date: Nov. 14, 2013

(54) SCHEDULING METHOD AND SCHEDULING SYSTEM

(71) Applicant: FUJITSU LIMITED, Kawasaki-shi (JP)

(72) Inventors: Hiromasa YAMAUCHI, Kawasaki (JP); Koichiro Yamashita, Hachioji (JP); Tetsuo Hiraki, Kawasaki (JP); Koji Kurihara, Kawasaki (JP); Toshiya Otomo, Kawasaki (JP)

(21) Appl. No.: 13/945,071

(22) Filed: Jul. 18, 2013

Related U.S. Application Data
(63) Continuation of application No. PCT/JP2011/051117, filed on Jan. 21, 2011.

(51) Int. Cl. G06F 9/46

(52) U.S. Cl. CPC G06F 9/46
USPC 718/102

(57) ABSTRACT

A scheduling method is performed by a scheduler that manages plural processors including a first processor and a second processor. The scheduling method includes assigning an application to the first processor when the application is started; instructing the second processor to calculate load of the processors; and maintaining assignment of the application or changing assignment of the application based on the load.

### CROSS REFERENCE TO RELATED APPLICATIONS

This application is a continuation application of International Application PCT/JP2011/051117, filed on Jan. 21, 2011 and designating the U.S., the entire contents of which are incorporated herein by reference.

### FIELD

The embodiments discussed herein are related to a scheduling method and a scheduling system.

### BACKGROUND

In recent years, higher performance and lower power consumption are demanded of many information devices. To realize higher performance and lower power consumption, a system with a multi-core processor has been developed.

As an example of related arts, Japanese Laid-open Patent Publication Nos. 2004-272894 and H10-207717 disclose task switching in a microcomputer. Japanese Patent No. 4413924 discloses a power control of processor cores.

However, according to a conventional multi-core processor system, when an application is started, the application is executed after the scheduling of a processor to which the application is assigned. As a result, the conventional multi-core processor system requires a longer startup time than a single core executing an application.

### SUMMARY

According to an aspect of an embodiment, a scheduling method is performed by a scheduler that manages plural processors including a first processor and a second processor. The scheduling method includes assigning an application to the first processor when the application is started; instructing the second processor to calculate load of the processors; and maintaining assignment of the application or changing assignment of the application based on the load.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting one example of scheduling process of a multi-core processor system according to embodiments;

FIG. 2 is a diagram depicting one example of a multi-core processor system according to the embodiments;

FIG. 3 is a diagram depicting one example of a divider;

FIG. 4 is a diagram depicting a functional configuration of a scheduler according to the embodiments;

FIG. 5 is a flowchart (part I) depicting one example of a scheduling process performed by a scheduler according to the embodiments;

FIG. 6 is a flowchart (part II) depicting one example of a scheduling process performed by a scheduler according to the embodiments;

FIG. 7 is a flowchart depicting one example of an assignment destination determining process of CPU #1;

FIG. 8 is a flowchart depicting one example of a process executed by CPU #2; and

FIG. 9 is a diagram depicting one example of a multi-core processor system according to the embodiments.

### DESCRIPTION OF EMBODIMENTS

Preferred embodiments of a scheduling method and a scheduling system will be explained with reference to the accompanying drawings. The scheduling system according to the embodiments is a multi-core processor system including a multi-core processor having multiple cores. A multi-core processor may be a single processor with multiple cores or single-core processors arranged in parallel as long as multiple cores are provided. The embodiments below take single-core processors arranged in parallel as an example for simplicity.

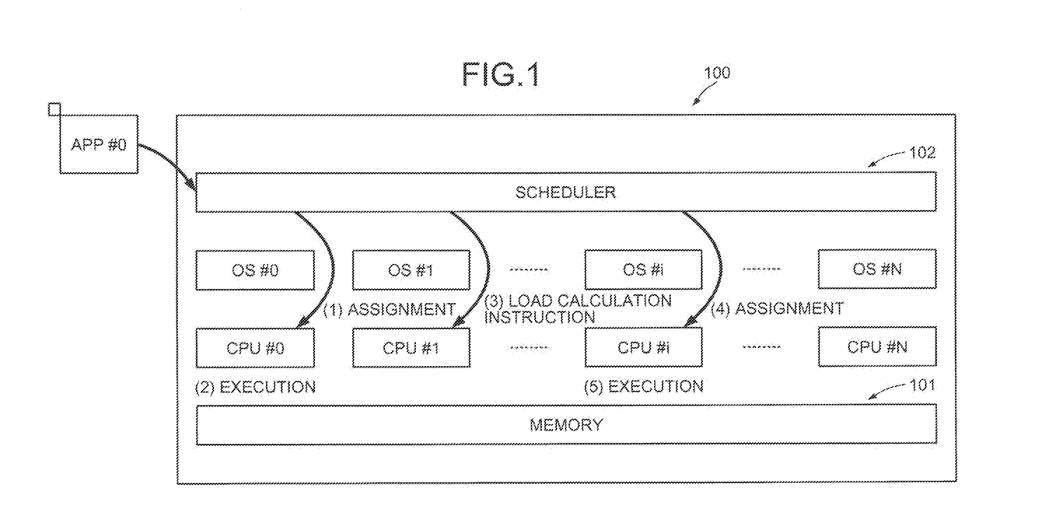

FIG. 1 is a diagram depicting one example of scheduling process of a multi-core processor system according to embodiments. In FIG. 1, a multi-core processor system 100 is a scheduling system including central processing units (CPUs) #0 to CPU #N, and memory 101.

CPU #0 executes an operating system (OS) #0 and governs overall control of the multi-core processor system 100. The OS #0 is a master OS and includes a scheduler 102 that controls to which CPU an application assigned. CPU #0 executes an assigned application.

CPU #1 to CPU #N execute OS #1 to OS #N respectively and applications assigned to each OS. OS #1 to OS #N are slave OSs. The memory 101 is common memory shared by CPU #0 to #N. CPU to which an application is assigned is equivalent in meaning to OS to which an application is assigned.

A scheduling process of the multi-core processor system 100 will be explained taking as an example, a case where app (application) #0 is started.

(1) in the multi-core processor system 100, the scheduler 102 assigns app #0 to CPU #0 when app #0 is started.

(2) CPU #0 begins to run app #0 after app #0 is assigned. For example, CPU #0 reads out execution information of app #0 from the memory 101 and executes app #0. The execution information is, for example, instruction code of app #0.

(3) The scheduler 102 instructs CPU #1 to calculate the load of CPU #0 to CPU #N. As a result, the load of each CPU #0 to #N is calculated by CPU #1. As an example, a case where CPU #i has the smallest load will be explained.

(4) Eased on a result of the calculation, the scheduler 102 determines a CPU to which app #0 is to be assigned. For example, the scheduler 102 selects, from among CPU #1 to CPU #N, a CPU having smaller load than CPU #0 as a CPU to which app #0 is to be assigned.

In this example, app #0 is assigned to CPU #i having the smallest load among CPU #0 to CPU #N. As a result, CPU #0 stops the execution of app #0. Context information of app #0 is saved to a cache of CPU #0. The context information is transferred to a cache of CPU #i.

(5) CPU #i begins to execute app #0 after app #0 is assigned. For example, CPU #i reads out execution information of app #0 from the memory 101 and begins to execute app #0 with the context information of app #0 transferred to the cache of CPU #1.

According to the multi-core processor system 100, before the CPU to which newly activated app #0 is to be assigned is determined, the execution of app #0 can be tentatively started by CPU #0 that is in charge of control. After a CPU to which app #0 is to be assigned has been determined by CPU #1, CPU #0 can hand over app #0 to CPU #i which is determined to be a destination of app #0. In this way, the startup time of app #0 can be shortened in comparison with a case where CPU #0 determines which CPU receives app #0 and then the selected CPU #i begins to execute app #0.

A system configuration of the multi-core processor system 100 depicted in FIG. 1 will be explained. As an example, a case where CPUs within the multi-core processor system 100 is CPU #0, CPU #1, CPU #2, and CPU #3 (N=3) will be explained.

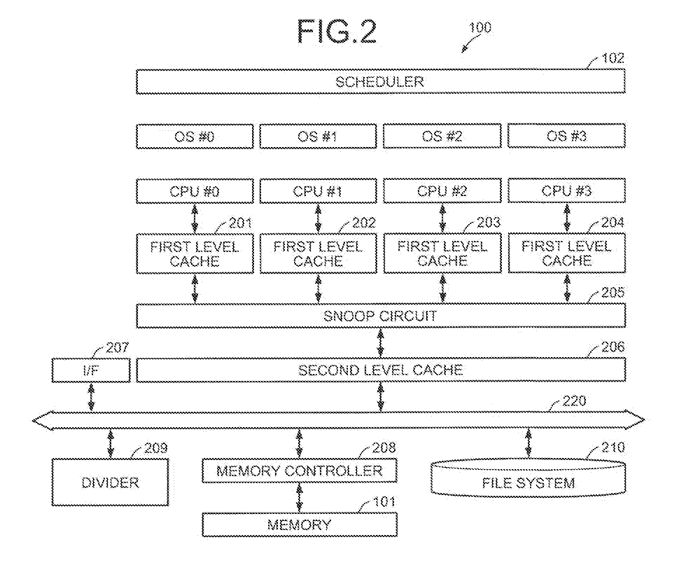

FIG. 2 is a diagram depicting one example of a multi-core processor system according to the embodiments. In FIG. 2, the multi-core processor system 100 includes CPU #0, CPU #1, CPU #2, CPU #3, the memory 101, a first level cache 201, a first level cache 202, a first level cache 203, a first level cache 204, a snoop circuit 205, a second level cache 206, an interface (I/F) 207, a memory controller 208, and a divider 209. In the multi-core processor system 100, the second level cache 206, the I/F 207, the memory controller 208, and the divider 209 are connected via a bus 220. The memory 101 is connected to each component via the memory controller 208.

CPU #0, CPU #1, CPU #2, and CPU #3 each have a register and a core. Each register has a program counter and a reset register. CPU #0 is connected to each component via the first level cache 201, the snoop circuit 205, and the second level cache 206. CPU #1 is connected to each component via the first level cache 202, the snoop circuit 205, and the second level cache 206. CPU #2 is connected to each component via the first level cache 203, the snoop circuit 205, and the second level cache 206. CPU #3 is connected to each component via the first level cache 204, the snoop circuit 205, and the second level cache 206.

The memory 101 is memory shared by CPU #0 to #3. For example, the memory 101 includes read only memory (ROM), random access memory (RAM), and flash ROM. The flash ROM stores programs of each OS. The ROM stores application programs. The RAM is used as a work area for CPU #0 to CPU #3. When loaded to a CPU, programs stored in the memory 101 cause the CPU to execute encoded processes.

The first level caches 201-204 each include cache memory and a cache controller. For example, the first level cache 201 temporarily stores a process of writing from an application executed by OS #0 to the memory 101. The first level cache 201 temporarily stores data read out of the memory 101.

The snoop circuit 205 ensures coherency among the first level caches 201-204 which CPU #0 to CPU #3 access. For example, when data shared by the first level caches 201-204 is updated in any one of the first level caches, the snoop circuit 205 detects the update and updates the other caches.

The second level cache 206 include cache memory and a cache controller. The second level cache 206 stores data that is removed from the first level caches 201-204. For example, the second level cache 206 stores data that is shared by OS #0 to #3.

The I/F 207 is connected to a network such as local area network (LAN), a wide area network (WAN), and the Internet via a communication line, and is connected to a device via the network. The I/F 207 governs the network and an internal interface, and controls the input and output of data with respect to an external device. The I\F 207 may be implemented by a LAN adaptor.

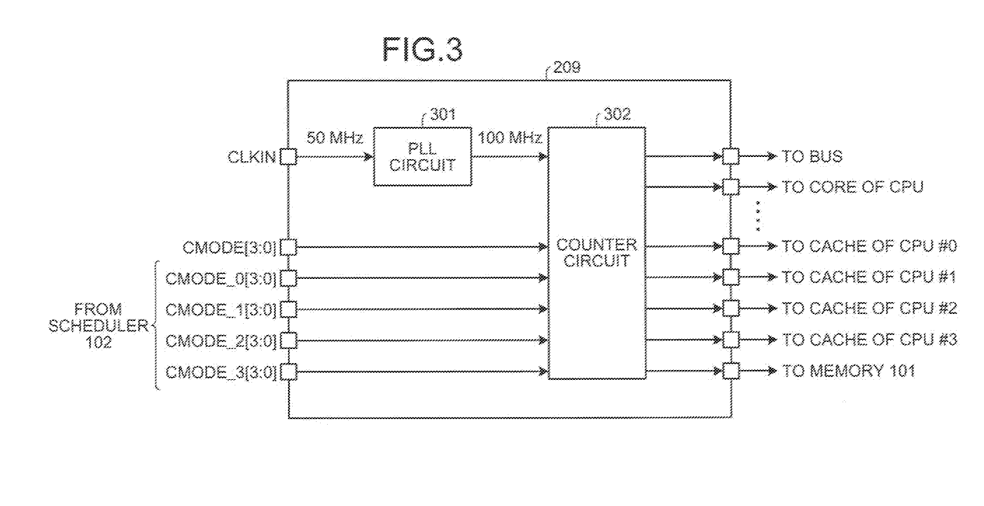

The memory controller 208 controls the reading and writing data with respect to the memory 101. The divider 209 is a source of a clock. For example, the divider 209 supplies a clock to CPU #0 to CPU #3, caches of each CPU, the bus 220, and the memory 101. Detail of the divider 209 will be given later with reference to FIG. 3.

A file system 210 stores, for example, instruction code of an application, and content data such as images and video. The file system 210 may be implemented by an auxiliary storage device such as a hard disk and an optical disk. The multi-core processor system 100 may include a power management unit (PMU) that supplies each component with power-supply voltage, a display, and a keyboard (not shown).

FIG. 3 is a diagram depicting one example of a divider. In FIG. 3, the divider 209 includes a phase-locked loop (PLL) circuit 301 that makes inter multiples of a clock, and a counter circuit 302 that divides a clock. The divider 209 receives CLKIN, CMODE [3:0], CMODE_0 [3:0], CMODE_1 [3:0], CMODE_2 [3:0], and CMODE_3 [3:0] and outputs clocks for each component.

At CLKIN, for example, a clock is input from an oscillating circuit. For example, when a clock of 50 MHz is input at CLKIN, the PLL circuit 301 doubles the frequency of the clock. The PLL circuit 301 supplies the clock of 100 MHz, the doubled frequency, to the counter circuit 302. The counter circuit 302 performs frequency dividing, dividing 100 MHz, based on values of CMODE [3:0], CMODE_0 [3:0], CMODE_1 [3:0], CMODE_2 [3:0], and CMODE_3 [3:0] and provides each resulting component. Frequency dividing means lowering the frequency; half frequency dividing indicates making the frequency ½; quarter frequency dividing indicates making the frequency ¼.

Based on a value input at CMODE_0 [3:0], the clock frequencies provided to the cache of CPU #0 and to the memory 101 are determined. Based on a value input at CMODE_1 [3:0], the clock frequencies provided to the cache of CPU #1 and to the memory 101 are determined.

Based on a value input at CMODE_2 [3:0], the clock frequencies provided to the cache of CPU #2 and to the memory 101 are determined. Based on a value input at CMODE_3 [3:0], the clock frequencies provided to the cache of CPU #3 and to the memory 101 are determined. Based on a value input at CMODE [3:0], the clock frequency provided to the components of the multi-core processor except the caches of each CPU and the memory 101 is determined.

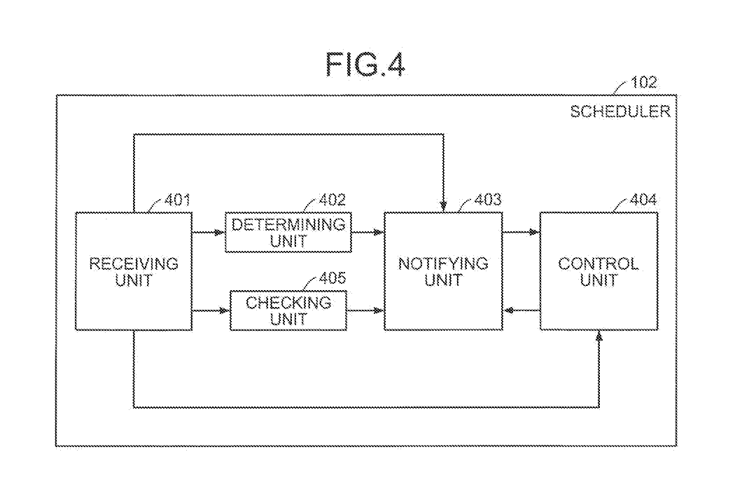

A functional configuration of the scheduler 102 will be explained. FIG. 4 is a diagram depicting a functional configuration of a scheduler according to the embodiments. In FIG. 4, the scheduler 102 includes a receiving unit 401, a determining unit 402, a notifying unit 403, a control unit 404, and a checking unit 405. Each functional element (receiving unit 401 to checking unit 405) is implemented by, for example, CPU #0 executing the scheduler 102 stored in the memory 101. Results of processing at each functional element are stored in, for example, a register of CPU #0, the first level cache 201, the second level cache 206, and the memory 101.

The receiving unit 401 receives an event notification. An event notification is, for example, an application startup notification, a termination notification, and a switch notification. For example the receiving unit 401 receives the application startup notification from the OS #0. In the description below, an application that is started and terminated is called “app #0” and an application to which the execution is switched is called “app #1”.

When the startup notification of app #0 indicating that app #0 is started is received, the determining unit 402 determines whether to overclock the clock frequency of CPU #0. Overclocking is to make the clock frequency of CPU #0 higher than a default clock frequency.

CPU #0 is a control CPU, a CPU for control, and has a lower clock frequency than CPU #2 or CPU #3, which are processing CPUs, CPUs for processing. Therefore, in order for CPU #0 to enable as high performance as the processing CPU, CPU #0 needs to change the clock frequency of CPU #0 to that of one of the processing CPUs.

If the clock frequency of CPU #0 is lower than the clock frequency of the processing CPU, the determining unit 402 determines to overclock the clock frequency of CPU #0. For example, the clock frequency of CPU #0 is 500 MHz and the clock frequency of CPU #2 is 1 GHz. In this case, the determining unit 402 determines to overclock the clock frequency of CPU #0 from 500 MHz to 1 GHz. The clock frequencies of CPU #0 to CPU #3 can be referenced by, for example, accessing a setting register of the divider 209,

If it is determined that the clock frequency of CPU #0 is overclocked, the notifying unit 403 notifies the divider 209 of the overclocking of the clock frequency of CPU #0. For example, the notifying unit 403 sends to the divider 209, a setting notification indicating that the clock frequency of CPU #0 is set to 1 GHz.

As a result, the clock frequency of CPU #0 is changed from 500 MHz to 1 GHz by the divider 209. If the divider 209 cannot change the clock frequency of CPU #0 to a requested value (for example, 1 GHz), the divider 209 may alter the clock frequency to the highest value possible,

The control unit 404 controls the execution of app #0 after the divider 209 is notified of the overclocking. For example, the control unit 404 assigns app #0 to CPU #0. As a result, CPU #0 reads out instruction codes of app #0 from the file system 210 to the memory 101. CPU #0 loads the instruction codes of app #0 from the memory 101 to the first level cache 201 and executes app #0.

When the startup notification is received, the notifying unit 403 notifies other CPUs of an instruction to search for a CPU to which app #0 is assigned. For example, the notifying unit 403 notifies CPU #1 of an instruction to search for a CPU to which app #0 is assigned. Like CPU #0, CPU #1 has a lower clock frequency than CPU #2 or CPU #3.

The load of each of CPU #0 to CPU #3 is calculated by CPU #1 and a CPU to which app #0 is assigned is determined. A detailed process of CPU #1 that has received an instruction to search for a CPU will be described later.

The receiving unit 401 receives an assignment result for app #0 from the CPU that has been notified of the instruction to search for a CPU to which app #0 is to be assigned. For example, the receiving unit receives the assignment result from CPU #1, the result indicating that app #0 has been assigned to CPU #0.

After receiving the assignment result for app #0, the control unit 404 maintains the assignment of app #0 to CPU #0. As a result, CPU #0 continues execution of app #0.

After receiving the assignment result for app #0, the checking unit 405 checks whether the clock frequency of CPU #0 is overclocked. For example, the checking unit 405 refers to a value in the setting register of the divider 209 indicating the clock frequency of CPU #0 and checks whether the clock frequency of CPU #0 is overclocked.

If the clock frequency of CPU #0 is overclocked, the checking unit 405 checks whether the default clock frequency of CPU #0 satisfies performance required by app #0. For example, the checking unit 405 checks whether the default clock frequency of CPU #0 is higher than the clock frequency that satisfies the performance demanded by app #0. The clock frequency that satisfies the performance demanded by app #0 is stored in, for example, the memory 101.

If the default clock frequency satisfies the performance demanded by app #0, the notifying unit 403 instructs the divider 209 to return the clock frequency of CPU #0 to the default clock frequency. For example, the notifying unit 403 notifies the divider of a setting notification that the clock frequency of CPU #0 is to be set to the default clock frequency. As a result, the divider 209 changes the clock frequency of CPU #0 to the default clock frequency.

The receiving unit 401 receives from a CPU to which app #0 has been assigned, a notification that execution information of app #0 has been loaded. For example, after CPU #2 to which app #0 is assigned loads instruction codes of app #0 from the memory 101, the receiving unit 401 receives, from CPU #2, a load completion notification indicating that instruction codes of app #0 have been loaded.

When the load completion notification concerning the execution information of app #0 is received, the control unit 404 stops the execution of app #0. For example, the control unit 404 moves the destination of assignment of app #0 from CPU #0 to CPU #2. As a result, CPU #0 saves runtime information of app #0 to the first level cache 201. The runtime information is, for example, context information such as a value in the program counter of CPU #0 or a value in a general register that stores a variable of a function.

As a result, the snoop circuit 205 transfers the runtime information in the first level cache 201 of CPU #0 to, for example, the first level cache 203 of CPU #2 to which app #0 is assigned, thereby maintaining the coherency of the cache memory between CPU #0 and CPU #2.

When the runtime information of app #0 is saved to the first level cache 201 and the coherency of the cache memory between CPU #0 and a CPU to which app #0 is assigned is maintained, the notifying unit 403 notifies the CPU of a request to start execution of app #0. As a result, app #0 is executed by CPU #2 to which app #0 is assigned.

If termination notification that app #0 is terminated is received, the checking unit 405 checks whether the clock frequency of CPU #0 is overclocked. If the clock frequency of CPU #0 is overclocked, the notifying unit. 403 instructs the divider 209 to change the clock frequency of CPU #0 to the default clock frequency. As a result, the clock frequency of CPU #0 is changed to the default clock frequency by the divider 209.

If a switch notification indicating that an application is switched from app #0 to app #1 is received, the checking unit 405 checks whether the default clock frequency of CPU #0 satisfies performance required by app #1. If the performance required by app #1 is satisfied and the clock frequency of CPU #0 is overclocked, the notifying unit 403 instructs the divider 209 to change the clock frequency of CPU #0 to the default clock frequency.

As a result, the clock frequency of CPU #0 is changed to the default clock frequency by the divider 209. The control unit 404 controls the execution of application #1. For example, the control unit 404 assigns app #1 to CPU #0. As a result, for example, CPU #0 loads instruction codes of app #1 to the first level cache 201 and starts executing app #1 using the runtime information of app #1 in the first level cache 201.

If the performance requirement of app #1 is not satisfied and the clock frequency of CPU #0 is not overclocked, the notifying unit 403 notifies the divider 209 of an instruction to overclock the clock frequency of CPU #0. As a result, the clock frequency of CPU #0 is overclocked by the divider 209. The control unit 404 controls the execution of app #1.

An example of a process conducted by a CPU that has received a search instruction to search for a CPU to which app #0 is to be assigned will be explained. It is assumed that CPU #1 receives from CPU #0, a search instruction to search for a CPU to which app #0 is to be assigned.

CPU #1 calculates the load of each of CPU #0 to CPU #3 when the search instruction is received. For example, CPU #1 calculates the load of each of CPU #0 to CPU #3 based on the number of applications assigned to each of CPU #0 to CPU #3 or based on the time for executing each application.

Based on the calculated load of each of CPU #0 to CPU #3, CPU #1 determines a CPU to which app #0 is to be assigned. For example, CPU #1 selects a CPU whose load is lowest among CPU #0 to CPU #3 as the CPU to which app #0 will be assigned.

CPU #1 notifies the selected CPU of the assignment result for app #0. For example, if CPU #0 is the CPU to which app #0 is to be assigned, CPU #1 notifies CPU #0 of a result that indicates that app #0 has been assigned to CPU #0. If a CPU other than CPU #0 receives app #0, CPU #1 notifies the CPU of an assignment result that includes a request to execute app

A request to execute app #0 is, for example, a load instruction in the instruction code of app #0. The request to execute app #0 includes information that identifies CPU #0, which is currently executing app #0. With this information, the CPU that receives app #0 can identify CPU #0 as the CPU that is currently executing app #0.

It is assumed here that CPU #2 receives app #0. When receiving a load instruction in the instruction codes of app #0 from CPU #1, CPU #2 loads the instruction codes of app #0 from the memory 101 to the first level cache 203. After loading the instruction codes of app #0, CPU #2 notifies CPU #0 of a load completion notification indicating that the instruction codes of app #0 have been completed.

When receiving the runtime information of app #0 from the snoop circuit 205, CPU #2 starts execution of app #0 using the instruction codes and the runtime information of app #0. In this way, app #0 that is tentatively executed by CPU #0, which is the control CPU, can be transferred to CPU #2, which is a processing CPU.

In the explanation above, CPU #1 that has received a search request to search for a CPU determines a CPU to which app #0 is assigned but the embodiments are not limited to this example. For example, the scheduler 102 may receive from CPU #1, a result of calculating the load of each of CPU #0 to CPU #3 and determines a CPU to which app #0 is to be assigned.

A scheduling process of the multi-core processor system 100 according to the embodiments will be explained. A scheduling process performed by the scheduler 102 according to the embodiments will be explained.

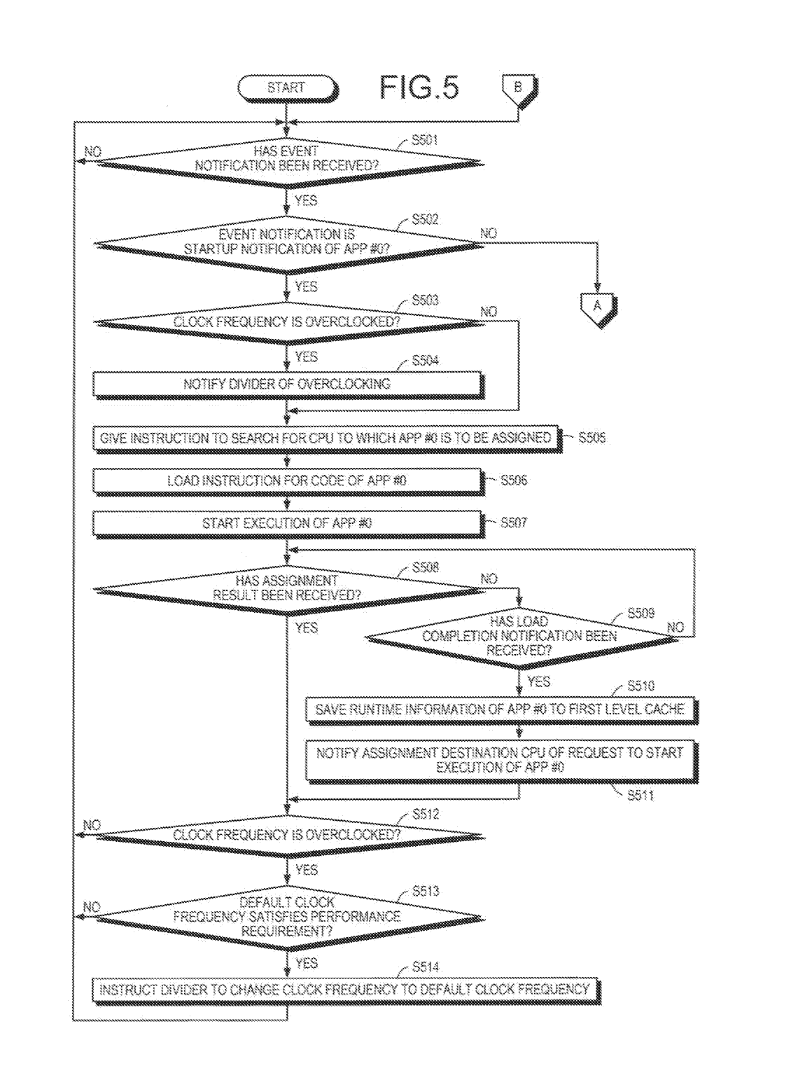

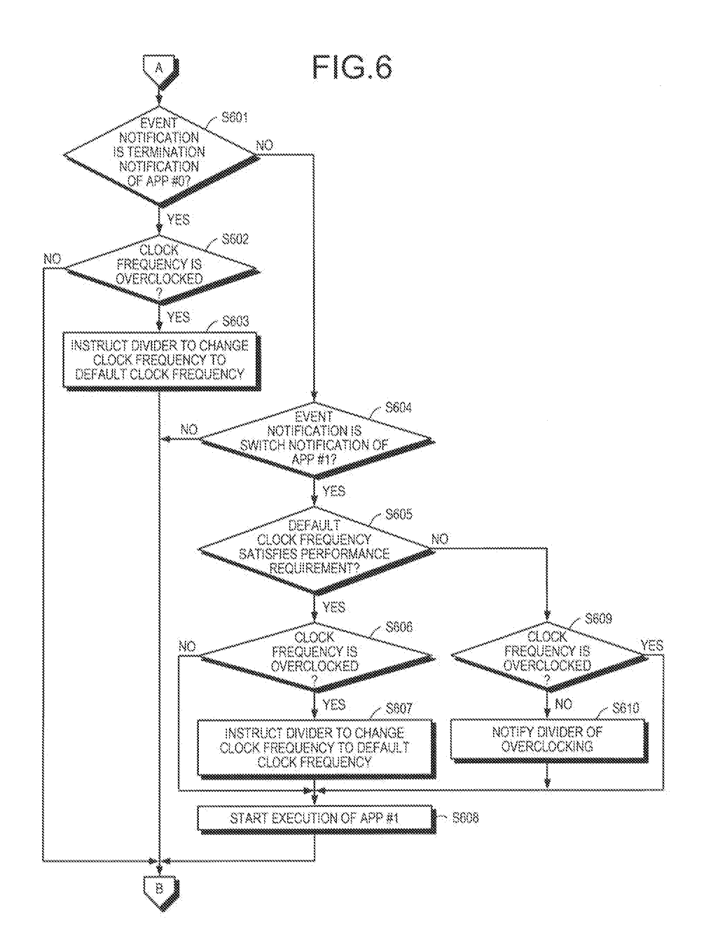

FIG. 5 and FIG. 6 are flowcharts depicting one example of a scheduling process performed by a scheduler according to the embodiments. In FIG. 5, CPU #0 checks whether an event notification has been received (step S501).

CPU #0 waits for an event notification to be received (step S501: NO). When an event notification has been received (step S501: YES), CPU #0 determines whether the event notification is a startup notification of app #0 (step S502).

If the received event notification is not a startup notification of app #0 (step S502: NO), the process goes to step S601 depicted in FIG. 6. If the received event notification is a startup notification of app #0 (step S502: YES), CPU #0 determines whether to overclock the clock frequency of CPU #0 (step S503).

If the clock frequency of CPU #0 is not to be overclocked (step S503: NO), the process goes to step S505. If the clock frequency of CPU #0 is to be overclocked (step S503: YES), CPU #0 notifies the divider 209 that the clock frequency of CPU #0 is to be overclocked (step S504).

CPU #0 notifies CPU #1 of a search instruction to search for a CPU to which app #0 is to be assigned (step S505). CPU #0 loads the instruction codes of app #0 (step S506) and begins to execute app #0 (step S507).

CPU #0 determines whether an assignment result for app #0 has been received from CPU #1 (step S508). If an assignment result for app #0 has been received (step S508: YES), the process goes to step S512.

If an assignment result for app #0 is not received (step S508: NO), CPU #0 determines whether load completion notification for the instruction codes of app #0 has been received from the CPU to which app #0 is assigned (step S509). If load completion notification has not been received (step S509: NO), the process goes to step S508.

If load completion notification has been received (step S509: YES), CPU #0 saves the runtime information of app #0 to the first level cache 201 (step S510). As a result, the runtime information of app #0 is transferred to the first level cache of the CPU to which app #0 is assigned.

CPU #0 notifies the CPU of a request to start the execution of app #0 (step S511). CPU #0 checks whether the clock frequency of CPU #0 has been overclocked (step S512). If the clock frequency has not been overclocked (step S512: NO), the process returns to step S501.

If the clock frequency has been overclocked (step S512: YES), CPU #0 determines whether the default clock frequency of CPU #0 satisfies the performance required by app #0 (step S513). If the default clock frequency does not satisfy the performance (step S513: NO), the process returns to step S501.

If the default clock frequency satisfies the performance (step S513: YES), CPU #0 instructs the divider 209 to change the clock frequency of CPU #0 to the default clock frequency (step S514) and the process returns to step S501.

In the flowchart of FIG. 6, CPU #0 determines whether the event notification received at step S501 in FIG. 5 is termination notification for app #0 (step S601).

If the event notification received is termination notification for app #0 (step S601: YES), CPU #0 checks whether the clock frequency of CPU #0 has been overclocked (step S602). If the clock frequency of CPU #0 has not been overclocked (step S602: NO), the process goes to step S501 of FIG. 5.

If the clock frequency of CPU #0 has been overclocked (step S602: YES), CPU #0 instructs the divider 209 to change the clock frequency of CPU #0 to the default clock frequency (step S603) and the process goes to step S501 of FIG. 5.

If the event notification received is not termination notification for app #0 at step S601 (step S601: NO), CPU #0 determines whether the event notification received is switch notification for app #1 (step S604). If the event notification received is not switch notification for app #1 (step S604: NO), the process goes to step S501 of FIG. 5.

If the event notification received is switch notification for app #1 (step S604: YES), CPU #0 determines whether the default clock frequency of CPU #0 satisfies the performance requirement of app #1 (step S605). If the performance requirement of app #1 is satisfied (step S605: YES), CPU #0 determines whether the clock frequency of CPU #0 has been overclocked (step S606).

If the clock frequency of CPU #0 has not been overclocked (step S606: NO), the process goes to step S608. If the clock frequency of CPU #0 has been overclocked (step S606: YES), CPU #0 instructs the divider 209 to change the clock frequency of CPU #0 to the default clock frequency (step S607).

CPU #0 begins to execute app #1 (step S608) and the process goes to step S501 depicted in FIG. 5. If the performance requirement of app #1 is not satisfied at step S605 (step S605: NO), CPU #0 determines whether the clock frequency of CPU #0 has been overclocked (step S609).

If the clock frequency of CPU #0 has been overclocked (step S609: YES), the process goes to step S608. If the clock frequency of CPU #0 has not been overclocked (step S609: NO), CPU #0 notifies the divider 209 of the overclocking of the clock frequency of CPU #0 (step S610) and the process goes to step S608.

In this way, the startup time of app #0 can be shortened in comparison with a case where after CPU #0 determines a CPU to which app #0 is assigned, the selected CPU begins to execute app #0.

An assignment destination determining process of CPU #1 that has received a search instruction to search for a CPU to which app #0 is assigned will be described.

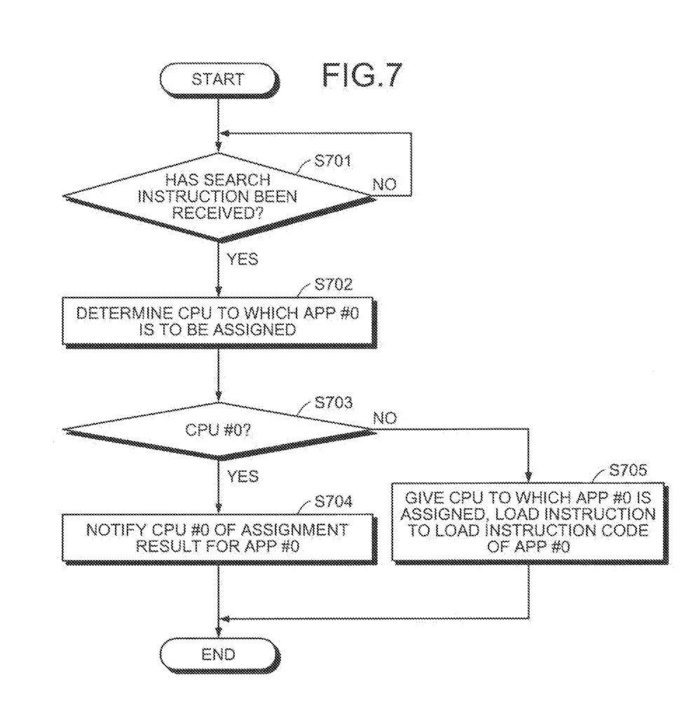

FIG. 7 is a flowchart depicting one example of an assignment destination determining process of CPU #1. In the flowchart of FIG. 7, CPU #1 checks whether a search instruction to search for a CPU to which app #0 is to be assigned has been received from CPU #0 (step S701).

CPU #1 waits for the instruction (step S701: NO). When the instruction is received (step S701: YES), CPU #1 determines a CPU to which app #0 is to be assigned (step S702). CPU #1 checks whether the destination of assignment of app #0 is CPU #0 (step S703).

If the destination of assignment is CPU #0 (step S703: YES), CPU #1 notifies CPU #0 of the assignment result for app #0 (step S704) and the process according to the flowchart ends.

If the destination of assignment is not CPU #0 (step S703: NO), CPU #1 notifies the CPU of the destination of assignment of the load instruction instructing the instruction code of app #0 to be loaded (step S705) and the process according to the flowchart ends.

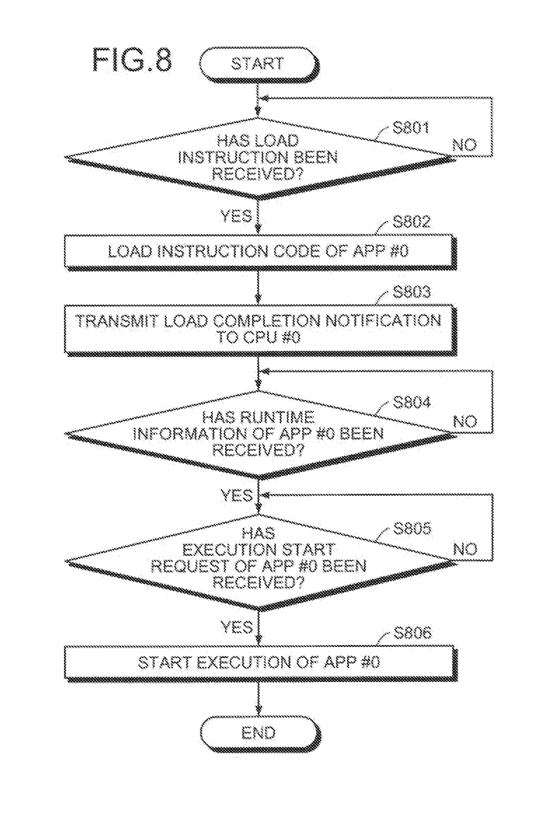

In this way, the destination of assignment of app #0 is determined and the CPU of the destination of assignment can be notified of the assignment result for app #0. When the destination of assignment of app #0 determined at step S702 is CPU #1, CPU #1 performs the process of steps S802 to S806 depicted in FIG. 8.

A process executed by CPU #2 will be explained taking as an example of a case where CPU #2 is selected as the destination of assignment of app #0 at step S702 depicted in FIG. 7.

FIG. 8 is a flowchart depicting one example of the process executed by CPU #2. In the flowchart of FIG. 8, CPU #2 checks whether CPU #2 has received from CPU #1, a load instruction to load the instruction codes of app #0 (step S801).

CPU #2 waits for a load instruction (step S801: NO). When the load instruction has been received (step S801: YES), CPU #2 loads the instruction code of app #0 (step S802). CPU #2 transmits to CPU #0, load completion notification indicating that loading of the instruction codes of app #0 has been completed (step S803).

CPU #2 checks whether the runtime information of app #0 has been received from CPU #0 (step S804). CPU #2 waits for the runtime information of app #0 (step S804: NO). When the runtime information is received (step S804: YES), CPU #2 checks whether an execution start request concerning app #0 that requests the starting of execution of app #0 has been received from CPU #0 (step S805).

CPU #2 waits for the execution start request (step S805: NO). When the execution start request is received (step S805: YES), CPU #2 starts the execution of app #0 (step S806) and the process according to the flowchart ends.

In this way, app #0 being executed by CPU #0, a control CPU, is transferred to CPU #2, a processing CPU.

One example of the multi-core processor system 100 according to the embodiments will he explained.

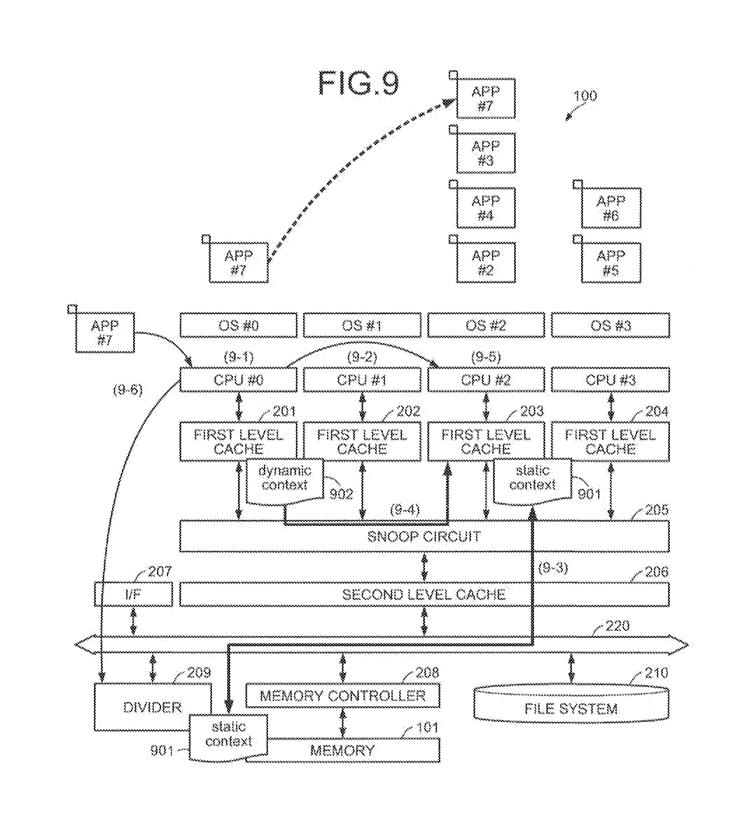

FIG. 9 is a diagram depicting one example of a multi-core processor system according to the embodiments. In FIG. 9, the scheduler 102 possessed by OS #0 is omitted,

(9-1) When a new app #7 is started in the multi-core processor system 100, CPU #0 starts execution of app #7 with the clock frequency overclocked. (9-2) CPU #1 chooses a CPU to which app #7 is to be assigned. It is assumed here that CPU #2 is chosen as the destination of assignment of app #7.

(9-3) CPU #2 loads the instruction codes of app #7 (“static context 901” in FIG. 9) from the memory 101 to the first level cache 203. (9-4) CPU #2 receives, via the snoop circuit 205, the runtime information (“dynamic context 902” in FIG. 9) of app #7 evacuated in the first level cache 201 of CPU #0.

(9-5) CPU #2 starts execution of app #7, (9-6) CPU #0 instructs the divider 902 to change the clock frequency of CPU #0 to the default clock frequency. As a result, the startup time of app #7 is sped up in comparison with a case where CPU #2 starts execution of app #7 after the destination of assignment of app #7 is determined by CPU #0.

As described above, according to the embodiments, before the destination of assignment of newly activated app #0 is determined, a control CPU #0 tentatively starts execution of app #0. When the destination of assignment of app #0 has been determined, CPU #0 transfers the app to the CPU that is the destination of assignment. As a result, the startup time of app #0 is sped up in comparison with a case where a CPU, the destination of assignment, starts execution of app #0 after CPU #0 determines the destination of assignment of app #0.

Further, according to the embodiments, if the clock frequency of CPU #0 is lower than the clock frequency of the processing CPU, the clock frequency of CPU #0 is overclocked and the execution of app #0 can be started. As a result, the control CPU #0 can execute app #0 at the same performance as the processing CPU.

Further, according to the embodiments, when the default clock frequency of CPU #0 satisfies a performance required by app #0, the overclocked clock frequency of CPU #0 is restored to the default clock frequency. As a result, power consumption is reduced.

Further, according to the embodiments, when the execution of app #0 by CPU #0 is finished, the overclocked frequency of CPU #0 is restored to the default clock frequency. As a result, power consumption is reduced.

The scheduling method in the embodiments can be implemented by a computer, such as a personal computer and a workstation, executing a program that is prepared in advance. The scheduling program is recorded on a computer-readable recording medium such as a hard disk, a flexible disk, a CD-ROM, an MO, and a DVD, and is executed by being read out from the recording medium by a computer. The program can be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A scheduling method performed by a scheduler that manages a plurality of processors including a first processor and a second processor, the scheduling method comprising:
assigning an application to the first processor when the application is started;
instructing the second processor to calculate load of the processors; and
maintaining assignment of the application or changing assignment of the application based on the load.

2. The scheduling method according to claim 1, wherein a clock frequency of the first processor is changed when the application is assigned.

3. The scheduling method according to claim 1, wherein the first processor starts execution of the application when the application is assigned.

4. The scheduling method according to claim 1, wherein the scheduler moves the application to a third processor when load of the first processor is larger than load of the third processor.

5. The scheduling method according to claim 1, wherein execution information and context information of the application in the first processor is given to the third processor when the application is moved to the third processor.

6. A scheduling system comprising:
a plurality of processors including a first processor and a second processor; and
a scheduler that manages the processors, wherein the first processor starts execution of an application started,
the second processor instructs calculation of load of the processors, and
the scheduler, based on the load, maintains assignment of the application to the first processor or changes assignment of the application to a third processor.

7. The scheduling system according to claim 6, further comprising a divider that changes a clock frequency of the first processor before the application is executed.

8. The scheduling system according to claim 6, wherein the scheduler changes assignment of the application to the third processor when the load of the first processor is larger than load of the third processor.

9. The scheduling system according to claim 6, wherein the scheduler gives execution information and context information of the application in the first processor to the third processor.
